(19) United States
(12) Patent Application Publication
(10) Pub. No.: US 2002/0118533 A1
(43) Pub. Date: Aug. 29, 2002

(54) Illuminated cap and shoe set

(76) Inventor: Jez Marston, Mitchellville, MD (US)

Correspondence Address: CAHN & SAMUELS LLP, 2000 P STREET NW, SUITE 200, WASHINGTON, DC, 20036, US

(21) Appl. No.: 09/963,787

(22) Filed: Sep. 27, 2001

Related U.S. Application Data
(60) Provisional application No. 60/235,572, filed on Sep. 27, 2000.

(51) Int. Cl. F21V 21/084

(52) U.S. Cl. 362/106

(57) ABSTRACT

A combination cap and shoe set is provided wherein each of the cap and shoe include illuminated regions. For example, the brim of the hat may be illuminated in its entirety in a particular color and the sole of the shoe may be illuminated in a complementary color such that a person wearing the cap and shoe of the invention in low light situations may be readily visible.

This application claims the benefit of Provisional Patent Application No. 60/235,572 file Sep. 27, 2000.

### FIELD OF THE INVENTION

The present invention relates to headgear having safety enhancing features. More particularly, the present invention relates to caps and/or hats having brims that are fully illuminated.

### BACKGROUND OF THE INVENTION

Night safety for outdoor exercisers, e.g., joggers, pedestrians and cyclists, is an ongoing concern. Most people exercise outdoors either early in the morning before going to work or in the evening or at night after returning from work. In crowded urban environments, outdoor exercisers must frequently share the roads with motorists. Dawn and dusk are periods in which motorist's visibility is notoriously poor. Accordingly, exercisers must take extra precautions to ensure that they are visible to motorists. In recent years, many exercisers have begun wearing bright or fluorescent colored clothing and/or passive reflectors. However, because these are purely reflective elements, it is necessary for them to be illuminated by an external light source, such as the beam of a motorists headlight, in order for them to function.

There are a several patents directed to caps having light sources attached to their brims. Some patents include caps having external, directed light sources attached to their brims. See for example, U.S. Pat. Nos. 4,406,040 and 5,741,060. The purpose of having light sources on these hats is to enhance the user's visibility so that the user can perform a desired task. However, these hats are not well suited for exercise activities such as jogging, walking or cycling because of the bulky nature of the light source attachment mechanisms. In addition, although they do emit light, they are not designed to make the wearer more visible in low light conditions.

There are still other illuminated caps that employ decorative lighting. For example, U.S. Pat. No. D318,338 includes a light source disposed at the center of the crown of the cap. U.S. Pat. No. 5,510,961 discloses a cap having several LEDs disposed along the perimeter of the brim. Neither of these patents is well suited to making the wearer more visible during low light situations.

### SUMMARY OF THE INVENTION

In accordance with a preferred aspect of the invention, a cap having an illuminated region is provided that includes a crown and that may optionally include a brim extending from the crown. The crown is preferably provided with a plurality of seams. One or more of the brim and the seams may be illuminated by, e.g., small light emitting diodes embedded therein. The light emitting diodes may be tinted to radiate light of a particular color, if desired.

In accordance with another embodiment of the invention, athletic shoes having illuminated regions may be provided in combination with the illuminated cap. The illuminated regions on the athletic shoes preferably include the soles, the tongue and decorative material on the surface of the shoes.

### DETAILED DESCRIPTION OF THE EMBODIMENTS

The present invention is directed to illuminated caps and shoes individually and in combination. A cap is provided with a plurality of illumination points to make the wearer more visible in low light situations. One or more of the brim of the cap, the seams of the crown of the cap and the button at the junction of the seams of the cap may be illuminated in accordance with the invention. Likewise, an athletic shoe may be provided with a plurality of illuminated regions including the tongue of the shoe, the entire sole of the shoe or portions thereof, the supporting material for the shoelace eyelets, decorative stripes disposed on the side of the shoe as well as other regions.

With respect to the cap, the illuminated brim is preferably the same size and shape as a regular brim that one would see in an ordinary baseball cap. There could be many different colored brims and hat matches, for instance the hat itself could be white while the brim is blue or any other color, or the hat could be red with a red illuminated brim. There are almost countless combinations. The brim is preferably comprised of a plastic or PLEXIGLAS® type of material molded into the shape of a regular brim that one would see today on a regular baseball cap. Likewise, the other illuminated regions may be of the same or different colors from each other. The owner of the cap has the choice of having his hat illuminated or off because of a switch that is preferably concealed underneath the material of the head fitting part of the hat. The owner of the hat can operate this switch through the material or fabric. The illuminated regions of the shoe may be color coordinated with the hat, if desired to present a well-coordinated apparel accessory set.

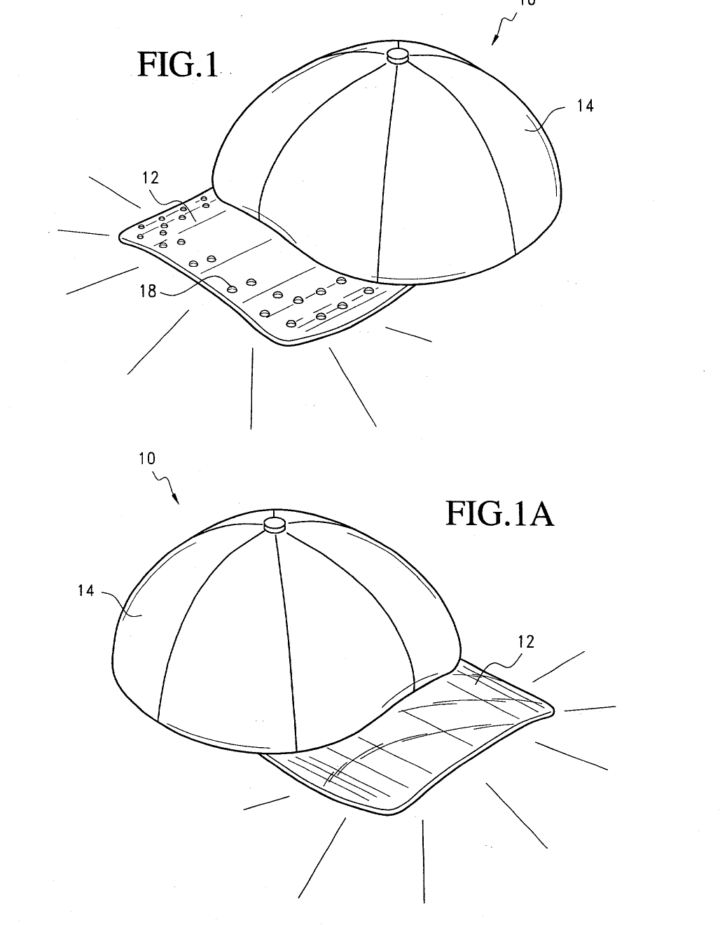

FIG. 1 depicts a cap according to the invention. As illustrated, a cap 10 includes a brim 12 and a crown 14. Cap 10 may be in the style of a baseball cap, a fishing cap, or any other hat/cap that employs a brim. Brim 12 is preferably formed from polymeric material that permits substantial transmission of light, e.g. PLEXIGLAS®. Crown 14 may be formed from a breathable fabric such as cotton or canvas and brim 12 may be attached to crown 14 by any well known method.

In accordance with an aspect of the invention, a light source 16 is provided to illuminate brim 12. Light source 16 may include light emitting elements 18 and a power source 20 and switch 22. Alternatively, a single light source may be provided as illustrated in FIG. 1a. Light emitting elements 18, e.g., LEDs, are preferably embedded within brim 12 to facilitate maximum light generation. Upon illumination of light emitting elements 18, brim 12 may act as a lens and magnifies the intensity of light emitting elements 18 thus illuminating the entire surface area of brim 12 and creating significant radiation. If further enhancement of illumination is desired, small reflective particles may be embedded into brim 12. Power source 20 is a small battery with sufficient strength to power light emitting elements 18. Power source 20 is preferably disposed on an inner surface of crown 14 such that it is concealed from plain view.

To facilitate manual activation of lighting elements 18, switch 22 is preferably a small push button switch of type commonly known in the art. Switch 22 may be disposed within an interior crown sweatband or liner and thereby hidden from view. The wearer can illuminate brim 12 by simply applying pressure to the outer surface of crown 14 at the hidden switch 22.

In order to present a sleek, fashionable look, power source 20 and switch 22 are preferably concealed on an inner rim of crown 14. In addition, it may be desirable for the brim 12 to radiate colored light. To that end, lighting elements 18 may be colored and/or brim 12 may be tinted.

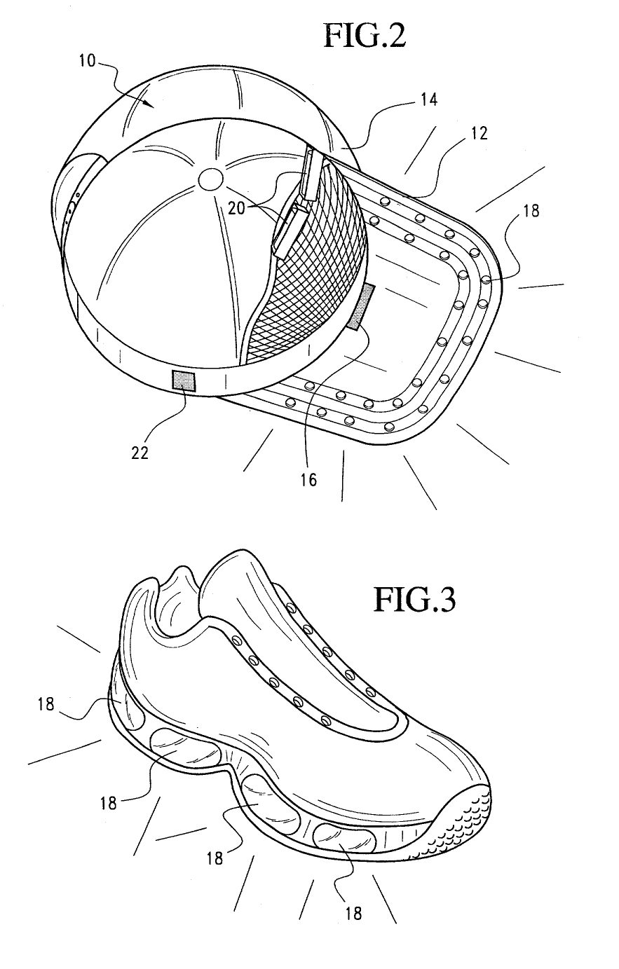

In accordance with another embodiment of the invention, the illuminated cap 10 described above may be combined with illuminated athletic shoes 30, as illustrated in FIG. 2. A suitable athletic shoe 30 is described U.S. Pat. No. 5,285,586 which is incorporated herein by reference. This combination may be worn as a fashion item or it may be used by performers such as dancers, actors marching band members and athletes in low light conditions to achieve special visual effects. For example, a marching band equipped with the combination illuminated hat and illuminated athletic shoes in accordance with the invention may present an impressive spectacle, as the individually illuminated heads and feet of its members move in synchronicity and create a symphony of light.

The inventive combination is also particularly useful for joggers, pedestrians and cyclists as illuminating the head and feet thereby significantly increasing visibility.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cap with an illuminated brim comprising:
a crown;
a brim extending from said crown;
a plurality of light emitting elements disposed within said brim; and
a switch concealed within said crown for operating said light emitting elements.

2. The cap according to claim 1 wherein said light emitting elements include LEDs.

3. The cap according to claim 1 wherein said brim is formed from polymeric material.

4. The cap according to claim 3 wherein said brim includes a lens.

5. The cap according to claim 4 further comprising a plurality of reflective members disposed embedded within said brim.

6. In combination an illuminated cap as claimed in claim 1 and an athletic shoe having an illuminated region.

7. The combination of claim 6 wherein the illuminated region of the shoe includes the tongue.

8. The combination of claim 6 wherein the illuminated region of the shoe includes a decorative stripe.
